(19) United States
(12) Patent Application Publication
(10) Pub. No.: US 2024/0412739 A1
(43) Pub. Date: Dec. 12, 2024

(54) SIGNAL CODING AND DECODING METHOD AND APPARATUS, AND CODING DEVICE, DECODING DEVICE AND STORAGE MEDIUM

(71) Applicant: BEIJING XIAOMI MOBILE SOFTWARE CO., LTD., Beijing (CN)

(72) Inventor: Shuo GAO, Beijing (CN)

(21) Appl. No.: 18/702,262

(22) PCT Filed: Oct. 21, 2021
(86) PCT No.: PCT/CN2021/125432

§ 371 Date: Apr. 17, 2024

(51) Int. Cl. G10L 19/008; G10L 19/02; G10L 25/06; G10L 25/51

(52) U.S. Cl. CPC G10L 19/008; G10L 19/0204; G10L 25/06; G10L 25/51

(57) ABSTRACT

A method for encoding or decoding a signal, performed by an encoding end, includes: obtaining audio signals, in which the audio signals include at least one object signal; obtaining an analysis result by performing signal feature analysis on the at least one object signal; obtaining at least one object signal set by classifying, based on the analysis result, the at least one object signal, and determining a respective encoding mode corresponding to each object signal set based on a classification result, in which the object signal set includes one or more object signals; and obtaining at least one piece of encoded object signal parameter information by encoding the one or more object signals in each object signal set using a respective encoding mode, writing the at least one piece of encoded object signal parameter information to an encoding bitstream and sending the encoding bitstream to a decoding end.

### CROSS-REFERENCE TO RELATED APPLICATION

This application is a US national phase of International Application No. PCT/CN2021/125432, filed on Oct. 21, 2021, the content of which is hereby incorporated by reference in its entirety.

### TECHNICAL FIELD

The disclosure relates to a field of communication technologies, in particular to signal encoding and decoding methods, related apparatuses, an encoding device, a decoding device and a storage medium.

### BACKGROUND

Since three-dimensional (3D) audio may give users a better stereoscopic and spatial immersion experience, the 3D audio has been widely used. When building a 3D audio experience, it is usually necessary to encode collected audio signals and transmit encoded signals to a playback device for playback.

### SUMMARY

According to a first aspect of embodiments of the disclosure, a signal encoding and decoding method, performed by an encoding end, is provided. The method includes:
obtaining audio signals, in which the audio signals include at least one object signal;
obtaining an analysis result by performing signal feature analysis on the at least one object signal;
obtaining at least one object signal set by classifying the at least one object signal based on the analysis result, and determining a respective encoding mode corresponding to each object signal set based on a classification result, in which each object signal set includes one or more object signals; and
obtaining at least one piece of encoded object signal parameter information by encoding each object signal included in the object signal set using a corresponding encoding mode, writing the object signal parameter information into an encoding bitstream and sending the encoding bitstream to a decoding end.

According to a second aspect of embodiments of the disclosure, a signal encoding and decoding method, performed a decoding end, is provided. The method includes:
receiving an encoding bitstream sent by an encoding end; and
obtaining at least one decoded object signal set by decoding the encoding bitstream.

According to a third aspect of embodiments of the disclosure, a communication device is provided. The communication device includes: a processor and a memory having a computer program stored thereon. When the processor executes the computer program stored in the memory, the communication device is caused to perform the method described in the first aspect above.

### BRIEF DESCRIPTION OF THE DRAWINGS

The above and/or additional aspects and advantages of the disclosure will become apparent and readily understood from the following description of embodiments in combination with the accompanying drawings.

FIG. 1 is a flowchart illustrating a signal encoding and decoding method according to an embodiment of the disclosure.

FIG. 2a is a flowchart illustrating a signal encoding and decoding method according to an embodiment of the disclosure.

FIG. 2b is a block diagram illustrating an ACELP encoding principle according to an embodiment of the disclosure.

FIG. 2c is a block diagram illustrating a frequency domain encoding principle according to an embodiment of the disclosure.

FIG. 2d is a flowchart illustrating a signal encoding method according to an embodiment of the disclosure.

FIG. 3a is a flowchart illustrating a signal encoding and decoding method according to an embodiment of the disclosure.

FIG. 3b is a flowchart illustrating a signal encoding method according to an embodiment of the disclosure.

FIG. 4a is a flowchart illustrating a signal encoding and decoding method according to an embodiment of the disclosure.

FIG. 4b is a flowchart illustrating a signal encoding method according to an embodiment of the disclosure.

FIG. 5 is a flowchart illustrating a signal encoding and decoding method according to an embodiment of the disclosure.

FIG. 6 is a flowchart illustrating a signal encoding and decoding method according to an embodiment of the disclosure.

FIG. 7 is a flowchart illustrating a signal encoding and decoding method according to an embodiment of the disclosure.

FIG. 8a is a flowchart illustrating a signal encoding and decoding method according to an embodiment of the disclosure.

FIG. 8b is a flowchart illustrating a signal decoding method according to an embodiment of the disclosure.

FIG. 8c is a flowchart illustrating a signal decoding method according to an embodiment of the disclosure.

FIG. 9 is a block diagram illustrating a signal encoding and decoding apparatus according to an embodiment of the disclosure.

FIG. 10 is a block diagram illustrating a signal encoding and decoding apparatus according to an embodiment of the disclosure.

FIG. 11 is a block diagram illustrating a user equipment (UE) according to an embodiment of the disclosure.

FIG. 12 is a block diagram illustrating a network side device according to an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the appended claims.

The terms used in the disclosure are only for the purpose of describing specific embodiments, and are not intended to limit embodiments of the disclosure. The singular forms of “a” and “the” used in the disclosure and appended claims are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in embodiments of the disclosure to describe various information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein may be interpreted as “when”, “while” or “in response to determining”.

In the related art, when the audio signals include a large number of object signals, the encoding method may include the following.

Method 1: each of the object signals is encoded respectively, and multiplexing all the encoded bits are multiplexed to form an encoding bitstream.

Method 2: the object signals are jointly encoded, and the jointly encoded bits are multiplexed to form an encoding bitstream.

Method 3: each of a portion of the object signals is encoded separately, the remaining object signals are jointly encoded, and the encoded bits are multiplexed to form an encoding bitstream.

However, the Method 1, the Method 2, and the Method 3 in the related art do not take into account an correlation between the object signals, which will result in a low data compression rate and fail to save bandwidth.

Methods for encoding or decoding a signal, related apparatuses, an encoding device, a decoding device and a storage medium according to embodiments of the disclosure will be described in detail below with reference to the accompanying drawings.

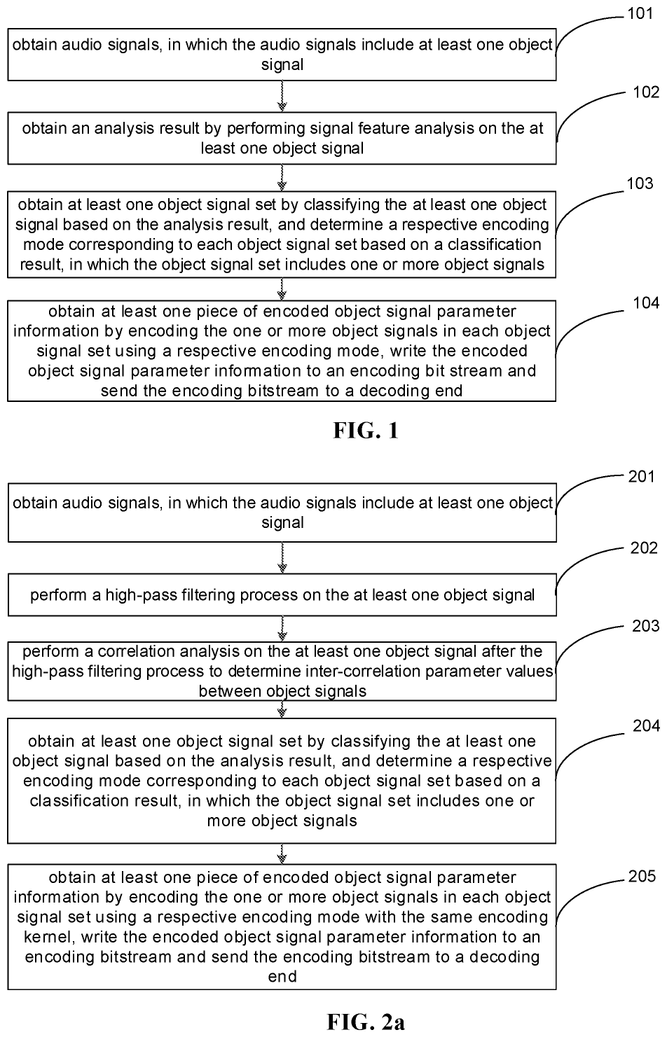

FIG. 1 is a flowchart illustrating a method for encoding or decoding a signal according to an embodiment of the disclosure. The method is performed by an encoding end. As illustrated in FIG. 1, the method includes the following.

At block 101, audio signals are obtained, in which the audio signals include at least one object signal.

In embodiments of the disclosure, the encoding end may be a user equipment (UE) (or called terminal device) or a base station. The UE may be a device that provides voice and/or data connectivity to a user. The UE may communicate with one or more core networks via a Radio Access Network (RAN). The UE may be an Internet of Things (IoT) terminal, such as a sensor device, a mobile phone (or “cellular” phone), and a computer with the IoT terminal. The UE may also be a stationary, portable, pocket-sized, handheld, computer-built, or vehicle-mounted device. For example, a Station (STA), a subscriber unit, a subscriber station, a mobile station, a mobile, a remote station, an access point, a remote terminal, an access terminal, a user terminal, or a user agent. Or, the UE may be an unmanned aerial vehicle device. Or, the UE may be an in-vehicle device, for example, an electronic control unit (ECU) having wireless communication function, or a wireless terminal external to the ECU. Or, the UE may also be a roadside device, for example, a street light, a signal light, or other roadside devices having wireless communication function.

In embodiments of the disclosure, the object signal may be any of object signals corresponding to various musical instruments or a singing signal. The object signal corresponding to a musical instrument may be, for example, a piano object signal, a flute object signal, a piccolo object signal, a clarinet object signal, etc.

At block 102, an analysis result is obtained by performing signal feature analysis on the at least one object signal.

In embodiments of the disclosure, the signal feature analysis may be an analysis of a cross-correlation parameter value between signals. In other embodiments of the disclosure, the signal feature analysis may be an analysis of a frequency band bandwidth range of a signal. The above two cases will be introduced in detail in subsequent embodiments.

At block 103, at least one object signal set is obtained by classifying the at least one object signal based on the analysis result, and a respective encoding mode corresponding to each object signal set is determined based on a classification result, in which the object signal set includes one or more object signals.

When the method of the signal feature analysis used in the block 102 is different, the method of classifying the object signals and the method of determining the respective encoding mode corresponding to each object signal set in this block may also be different.

In detail, in embodiments of the disclosure, when the method of the signal feature analysis used in the block 102 is analyzing the cross-correlation parameter value between signals, the classification method for the object signals in this block may be a classification method based on the cross-correlation parameter value between signals, and the method of determining the respective encoding mode corresponding to each object signal set may be determining a respective encoding mode corresponding to each object signal set based on the cross-correlation parameter value between signals.

In other embodiments of the disclosure, when the method of the signal feature analysis used in the block 102 is analyzing the frequency band bandwidth range of the signal, the classification method for the object signals in this block may be a classification method based on the frequency band bandwidth range of the signal, and the method of determining a respective encoding mode corresponding to each object signal set may be determining the respective encoding mode corresponding to each object signal set based on the frequency band bandwidth range of the signal.

The above-mentioned “classification method based on the cross-correlation parameter value between signals or the frequency band bandwidth range of the signal” and “determining the respective encoding mode corresponding to each object signal set based on the cross-correlation parameter value between signals or the frequency band bandwidth range of the signal” will be introduced in detail in subsequent embodiments.

It is noteworthy that, in embodiments of the disclosure, after the at least one object signal set is obtained through classification, the at least one object signal set may be preprocessed. The preprocessing may include at least one of a high-pass process, a pre-emphasis process, or a normalization process.

At block 104, at least one piece of encoded object signal parameter information is obtained by encoding the one or more object signals in each object signal set using a corresponding encoding mode, the encoded object signal parameter information is written into an encoding bitstream and the encoding bitstream is sent to a decoding end.

It is noteworthy that, in embodiments of the disclosure, when a classification manner for the object signals in the block 103 is different, the encoding condition of the at least one object signal set will be different.

In embodiments of the disclosure, in detail, the one or more object signals in the object signal set after preprocessing are encoded using a corresponding encoding mode.

In embodiments of the disclosure, the above-mentioned method of writing the encoded object signal parameter information into the encoding bitstream and sending the encoding bitstream to the decoding end may specifically include the following.

At step 1, a classification side information parameter is determined, in which the classification side information parameter is configured to indicate a classification manner for the object signals. For example, the classification side information parameter may indicate that the classification manner for the object signals is a classification method based on the cross-correlation parameter value between signals or a classification method based on the frequency band bandwidth range of the signal.

At step 2, a respective side information parameter corresponding to each object signal set is determined, in which the side information parameter is configured to indicate an encoding mode corresponding to the object signal set.

At step 3, the encoding bitstream is obtained by multiplexing the classification side information parameter, the respective side information parameter corresponding to each object signal set, and the encoded object signal parameter information and is sent to the decoding end.

In embodiments of the disclosure, the classification side information parameter and the respective side information parameter corresponding to each object signal set are sent to the decoding end, so that the decoding end may determine a corresponding encoding condition based on the classification side information parameter and determine a respective encoding mode corresponding to each object signal set based on the side information parameter corresponding to the object signal set. Therefore, each object signal set may be decoded using the corresponding decoding mode based on the encoding condition and the encoding mode.

In conclusion, in the method for encoding or decoding a signal according to embodiments of the disclosure, the signal feature analysis may be performed on the at least one object signal in the collected audio signals to obtain the analysis result. The at least one object signal may be classified based on the analysis result to obtain at least one object signal set. Meanwhile, the respective encoding mode corresponding to each object signal set may be determined based on the classification result. The one or more object signals in each object signal set may be encoded using a corresponding encoding mode. The signal feature analysis in embodiments of the disclosure includes the analysis of the cross-correlation parameter value between signals or the analysis of the frequency band bandwidth range of the signal. Therefore, in embodiments of the disclosure, the cross-correlation parameter value between signals or the frequency band bandwidth range of the signal is taken into account when determining the encoding mode, thereby ensuring the signal compression rate and saving bandwidth.

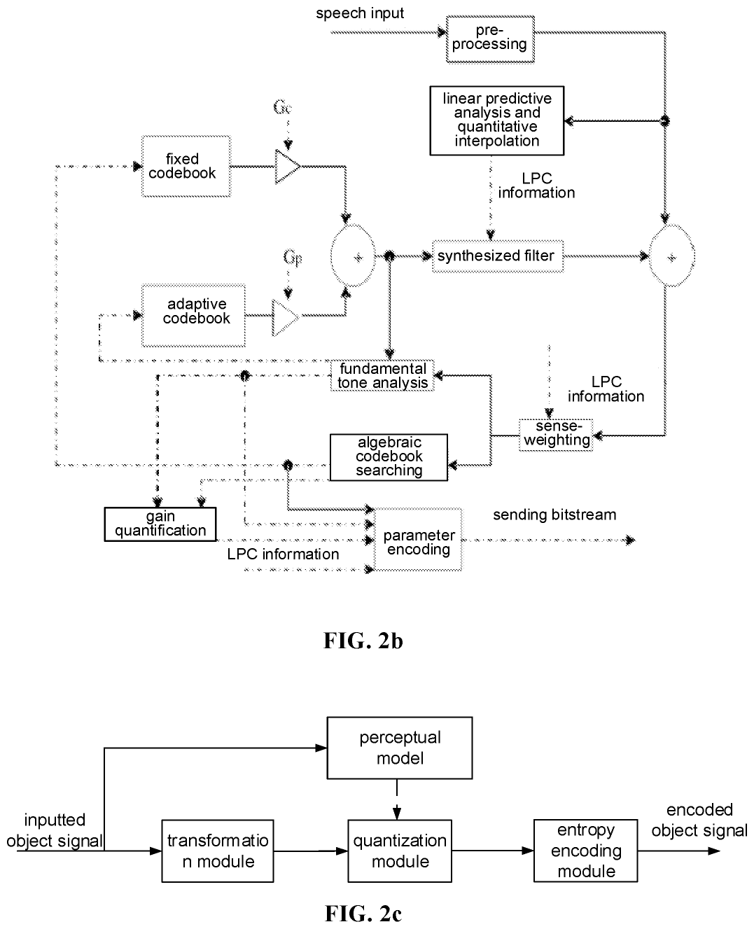

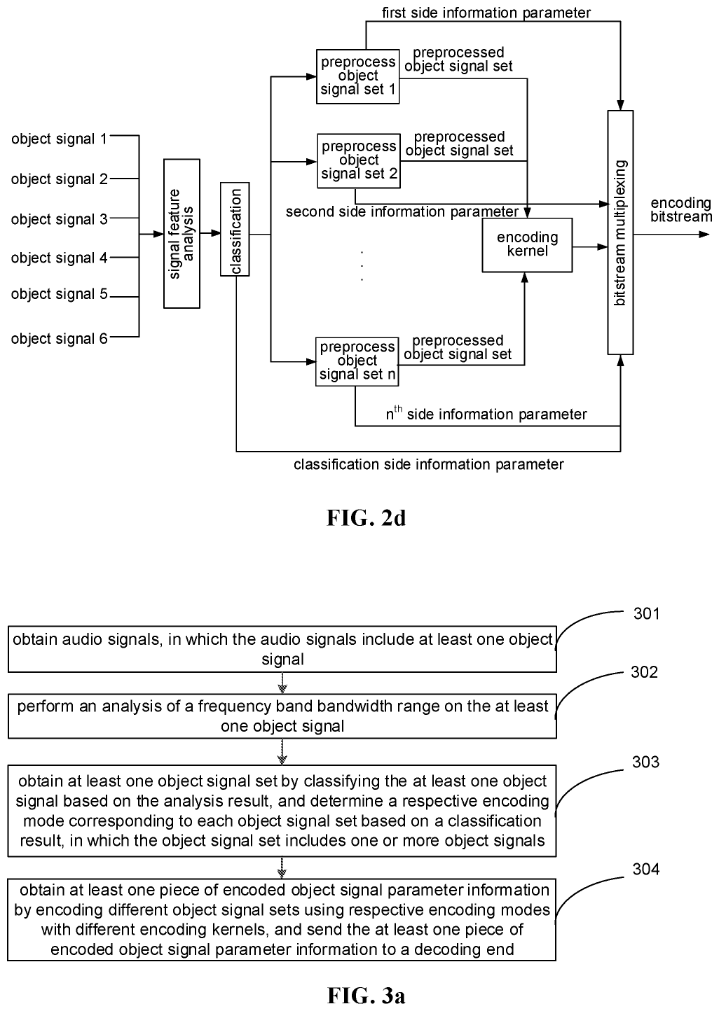

FIG. 2a is a flowchart illustrating a method for encoding or decoding a signal according to an embodiment of the disclosure. The method is performed by an encoding end. As illustrated in FIG. 2a, the method includes the following.

At block 201, audio signals are obtained, in which the audio signals include at least one object signal.

It is understandable that in this embodiment, the at least one object signal means two or more object signals.

At block 202, a high-pass filtering process is performed on the object signals.

In embodiments of the disclosure, a filter may be used to perform the high-pass filtering process on the object signals.

The cut-off frequency of this filter is set to 20 Hz. The filtering equation used by this filter may be as shown in equation (1) below:

$${H}_{20} ( Z ) = \frac{{b}_{0} + {b}_{1} {z}^{- 1} + {b}_{2} {z}^{- 2}}{1 + {a}_{1} {z}^{- 1} + {a}_{2} {z}^{- 2}} \qquad ( 1 )$$

where, a1, a2, b0, b1 and b2 are all constants. For example, b0=0.9981492, b1=−1.9963008, b2=0.9981498, a1=1.9962990, and a2=−0.9963056.

At block 203, a correlation analysis is performed on the object signals after the high-pass filtering process to determine cross-correlation parameter values between the object signals.

In embodiments of the disclosure, the above correlation analysis may adopt a calculation using the following equation (2):

$${η}_{xy} = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}} \qquad ( 2 )$$

where, η_{xy} indicates the cross-correlation parameter value between an object signal X and an object signal Y, Xi indicates an i^{th} signal of a signal sequence of the object signal X, Yi indicates an i^{th} signal of a signal sequence of the object signal Y, X indicates an average value of a signal sequence of the object signal X, and Y indicates an average value of a signal sequence of the object signal Y.

It is noteworthy that the above method of “calculating the cross-correlation parameter value in accordance with the equation (2)” is an optional way for embodiments of the disclosure. Moreover, it is noteworthy that other methods of calculating the cross-correlation parameter values between the object signals in the art may also be applied in the disclosure.

At block 204, at least one object signal set is obtained by classifying the at least one object signal based on the analysis result, and a respective encoding mode corresponding to each object signal set is determined based on a classification result, in which the object signal set includes one or more object signals.

In embodiments of the disclosure, obtaining the at least one object signal set by classifying the at least one object signal based on the analysis result, and determining the respective encoding mode corresponding to each object signal set based on the classification result include:
setting normalized correlation degree intervals based on correlation degrees; obtaining the at least one object signal set by classifying the at least one object signal based on the cross-correlation parameter values between the object signals and the normalized correlation degree intervals, and determining the corresponding encoding mode based on a respective correlation degree corresponding to each object signal set.

It is understandable that the number of normalized correlation degree intervals is determined based on a correlation degree division manner, which is not limited in the disclosure. Moreover, lengths of different normalized correlation degree intervals are not limited. The corresponding number of normalized correlation degree intervals and different interval lengths may be set based on the correlation degree division manner.

In embodiments of the disclosure, there are 4 types of correlation degrees, namely, weak correlation, substantive correlation, significant correlation and high correlation. Table 1 is a normalized correlation degree interval division table according to embodiments of the disclosure.

TABLE 1

| normalized | |
|---|---|
| correlation | |
| degree | |
| intervals | correlation degrees |
| 0.00~±0.30 | weak correlation |
| ±0.30-±0.50 | substantive correlation |
| ±0.50-±0.80 | significant correlation |
| ±0.80-±1.00 | high correlation |

Based on the above, as an example, object signals that the cross-correlation parameter value therebetween belongs to a first interval are classified into an object signal set 1, and it is determined that the object signal set 1 corresponds to an independent encoding mode.

Object signals that the cross-correlation parameter value therebetween belongs to a second interval are classified into an object signal set 2, and it is determined that the object signal set 2 corresponds to a joint encoding mode 1.

Object signals that the cross-correlation parameter value therebetween belongs to a third interval are classified into an object signal set 3, and it is determined that the object signal set 3 corresponds to a joint encoding mode 2.

Object signals that the cross-correlation parameter value therebetween belongs to a fourth interval are classified into an object signal set 4, and it is determined that the object signal set 4 corresponds to a joint encoding mode 3.

In embodiments of the disclosure, the first interval may be [0.00˜±0.30), the second interval may be [±0.30−±0.50), the third interval may be [±0.50−±0.80), and the fourth interval may be [±0.80−±1.00]. When the cross-correlation parameter value between object signals belongs to the first interval, it means that the object signals are weakly correlated with each other. In order to ensure the encoding accuracy, the independent encoding mode should be used for encoding. When the cross-correlation parameter value between object signals belongs to the second interval, the third interval or the fourth interval, it indicates that the object signals are relatively highly correlated with each other, and thus the joint encoding mode may be used for encoding to ensure the compression rate and save bandwidth.

In embodiments of the disclosure, the independent encoding mode corresponds to a time-domain processing manner or a frequency-domain processing manner. When object signal(s) in the object signal set 1 is/are speech signal(s) or speech-like signal(s), the independent encoding mode adopts the time-domain processing manner. When the object signal(s) in the object signal set 1 is/are audio signal(s) other than the speech signal and the speech-like signal, for example music signal(s), a mixture of speech signal and music signal, and a mixture of noise signal, speech signal and music signal), the independent encoding mode adopts the frequency-domain processing manner.

In embodiments of the disclosure, the above-described time domain processing manner may be implemented using an Algebraic Code-Excited Linear Prediction (ACELP) encoder. FIG. 2b is a block diagram illustrating an ACELP encoding principle according to an embodiment of the disclosure. The specific information about the ACELP encoding principle may be found from the related art, which is not repeated in embodiments of the disclosure.

In embodiments of the disclosure, the frequency domain processing manner described above may include a transform domain processing manner. FIG. 2c shows a block diagram illustrating a frequency domain encoding principle according to an embodiment of the disclosure. As illustrated in FIG. 2c, the inputted object signal may first be transformed to the frequency domain by performing a Modified discrete cosine transform (MDCT) via a transformation module. The transformation equation and the inverse transformation equation in the MDCT are equation (3) and equation (4):

$$X ( m ) = {\sum }_{k = 0}^{n - 1} f ( k ) x ( k ) cos ( \frac{π}{2 n} ( 2 k + 1 + \frac{n}{2} ) ( 2 m + 1 ) ) , \\ for m = 0 … \frac{n}{2} - 1 , \qquad Equation ( 3 )$$

$$y ( p ) = f ( p ) \frac{4}{n} {\sum }_{m = 0}^{\frac{n}{2} - 1} X ( m ) cos ( \frac{π}{2 n} ( 2 p + 1 + \frac{n}{2} ) ( 2 m + 1 ) ) , \\ for p = 0 … n - 1. \qquad Equation ( 4 )$$

Afterwards, the psychoacoustic model (or perceptual model) is used to adjust each frequency band for the object signal that is transformed into the frequency domain, a quantization module is used to quantize an envelope coefficient of each frequency band through bit distribution to obtain quantization parameters, and an entropy encoding module is used to perform an entropy encoding on the quantization parameters to output the encoded object signal.

At block 205, at least one piece of encoded object signal parameter information is obtained by encoding the one or more object signals in each object signal set using a corresponding encoding mode through the same encoding kernel, the encoded object signal parameter information is written to an encoding bitstream, and the encoding bitstream is sent to a decoding end.

In embodiments of the disclosure, the method of encoding all object signal sets using corresponding encoding modes includes:
encoding the object signal set 1 using the independent encoding mode;
encoding the object signal set 2 using the joint encoding mode 1;
encoding the object signal set 3 using the joint encoding mode 2; and
encoding the object signal set 4 using the joint encoding mode 3.

The description of “writing the encoded object signal parameter information to the encoding bitstream and sending the encoding bitstream to the decoding end” may be referred to above embodiments, and will not be repeated herein.

Finally, based on the above description, FIG. 2d is a flowchart illustrating a signal encoding method according to an embodiment of the disclosure.

In conclusion, in the method for encoding or decoding a signal according to embodiments of the disclosure, the signal feature analysis may be performed on the at least one object signal in the collected audio signals to obtain the analysis result. The at least one object signal may be classified based on the analysis result to obtain at least one object signal set. Meanwhile, the respective encoding mode(s) corresponding to the at least one object signal set may be determined based on the classification result. The one or more object signals in each object signal set may be encoded using a corresponding encoding mode. The signal feature analysis in embodiments of the disclosure includes the analysis of the cross-correlation parameter value between signals. As may be seen that in embodiments of the disclosure, the cross-correlation parameter value between signals is taken into account when determining the encoding mode, thereby ensuring the signal compression rate and saving bandwidth.

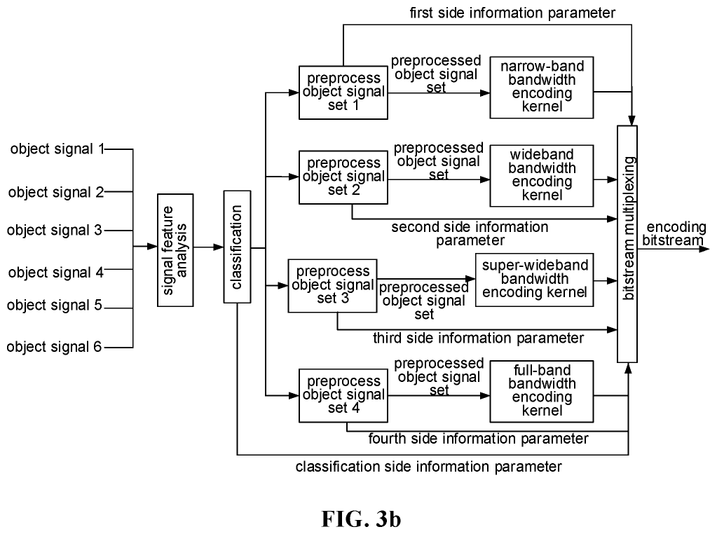

FIG. 3a is a flowchart illustrating a method for encoding or decoding a signal according to an embodiment of the disclosure. The method is performed by an encoding end. As illustrated in FIG. 3a, the method includes the following.

At block 301, audio signals are obtained, in which the audio signals include at least one object signal.

At block 302, an analysis of a frequency band bandwidth range is performed on the at least one object signal.

At block 303, at least one object signal set is obtained by classifying the at least one object signal based on the analysis result, and a respective encoding mode corresponding to each object signal set is determined based on a classification result, in which the object signal set includes one or more object signals.

In embodiments of the disclosure, obtaining the at least one object signal set by classifying the at least one object signal based on the analysis result, and determining the respective encoding mode corresponding to each object signal set based on the classification result include:
determining bandwidth intervals corresponding to different frequency band bandwidths; and
obtaining the at least one object signal set by classifying the at least one object signal based on the frequency band bandwidth ranges of the object signals and the bandwidth intervals corresponding to different frequency band bandwidths, and determining the corresponding encoding mode(s) based on the frequency band bandwidth(s) corresponding to the at least one object signal set.

The frequency band bandwidths of the signal typically include: a narrow band, a wideband, a super-wideband, and a full-band. The bandwidth interval corresponding to the narrow band may be a first interval, the bandwidth interval corresponding to the wideband may be a second interval, the bandwidth interval corresponding to the super-wideband may be a third interval, and the bandwidth interval corresponding to the full-band may be a fourth interval. The at least one object signal may be classified to obtain the at least one object signal set by determining the bandwidth interval(s) to which a respective frequency band bandwidth range of each object signal belongs. Afterwards, the corresponding encoding mode(s) is determined based on the frequency band bandwidth(s) corresponding to the at least one object signal set. The narrow band, the wideband, the super-wideband, and the full-band correspond to a narrowband encoding mode, a wideband encoding mode, a super-wideband encoding mode, and a full-band encoding mode respectively.

It is noteworthy that the lengths of different bandwidth intervals are not limited in embodiments of the disclosure, and it is possible that the bandwidth intervals of different frequency band bandwidths are overlapped.

For example, an object signal whose frequency band bandwidth range belongs to the first interval is classified into the object signal set 1, and it is determined that the object signal set 1 corresponds to the narrowband encoding mode.

An object signal whose frequency band bandwidth range belongs to the second interval is classified into the object signal set 2, and it is determined that the object signal set 2 corresponds to the wideband encoding mode.

An object signal whose frequency band bandwidth range belongs to the third interval is classified into the object signal set 3, and it is determined that the object signal set 3 corresponds to the ultra-wideband encoding mode.

An object signal whose frequency band bandwidth range belongs to the fourth interval is classified into the object signal set 4, and it is determined that the object signal set 4 corresponds to the full-band encoding mode.

In an embodiment of the disclosure, the first interval may be 0 to 4 kHz, the second interval may be 0 to 8 kHz, the third interval may be 0 to 16 kHz, and the fourth interval may be 0 to 20 kHz. When the frequency band bandwidth of an object signal belongs to the first interval, it means that the object signal is a narrow-band signal, and it is determined that the encoding mode corresponding to the object signal is using a relatively small number of bits for encoding (i.e., using the narrow-band encoding mode). When the frequency band bandwidth of an object signal belongs to the second interval, it means that the object signal is a wideband signal, and it is determined that the encoding mode corresponding to the object signal is using many bits for encoding (i.e., using the wideband encoding mode). When the frequency band bandwidth of an object signal belongs to the third interval, it means that the object signal is a super-wideband signal, and it is determined that the encoding mode corresponding to the object signal is using a relatively large number of bits for encoding (i.e., using the super-wideband encoding mode). When the frequency band bandwidth of an object signal belongs to the fourth interval, it means that the object signal is a full-band signal, and it is determined that the encoding mode corresponding to the object signal is using more bits for encoding (i.e., using the full-band encoding mode).

Therefore, signals with different frequency band bandwidths are encoded using different bits, to ensure the signal compression rate and save bandwidth.

At block 304, at least one piece of encoded object signal parameter information is obtained by encoding different object signal sets using corresponding encoding modes through different encoding kernels, and the encoded object signal parameter information is sent to a decoding end.

In embodiments of the disclosure, the method of encoding different object signal sets using corresponding encoding modes through different encoding kernels may include:
after determining a specific encoding mode based on the frequency band bandwidth corresponding to the object signal set in the above block 302, determining an encoding kernel corresponding to the encoding mode based on the encoding mode, and encoding the corresponding object signal set based on the encoding kernel.

For example, the object signal set 1 corresponds to the narrowband encoding mode, and a narrowband encoding kernel may be used to encode the object signal set 1.

The object signal set 2 corresponds to the wideband encoding mode, and a wideband encoding kernel may be used to encode the object signal set 2.

The object signal set 3 corresponds to the super-wideband encoding mode, and a super-wideband encoding kernel may be used to encode the object signal set 3.

The object signal set 4 corresponds to the full-band encoding mode, and a full-band encoding kernel may be used to encode the object signal set 4.

The description of “writing the encoded object signal parameter information to the encoding bitstream and sending the encoding bitstream to the decoding end” may be referred to above embodiments, which is not repeated herein.

Finally, based on the above-described contents, FIG. 3b is a flowchart illustrating a method for encoding a signal according to an embodiment of the disclosure.

In conclusion, in the method for encoding or decoding a signal according to embodiments of the disclosure, the signal feature analysis may be performed on the at least one object signal in the collected audio signals to obtain the analysis result. The at least one object signal may be classified based on the analysis result to obtain at least one object signal set. Meanwhile, the respective encoding mode corresponding to each object signal set may be determined based on the classification result. The one or more object signals in the object signal set will be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

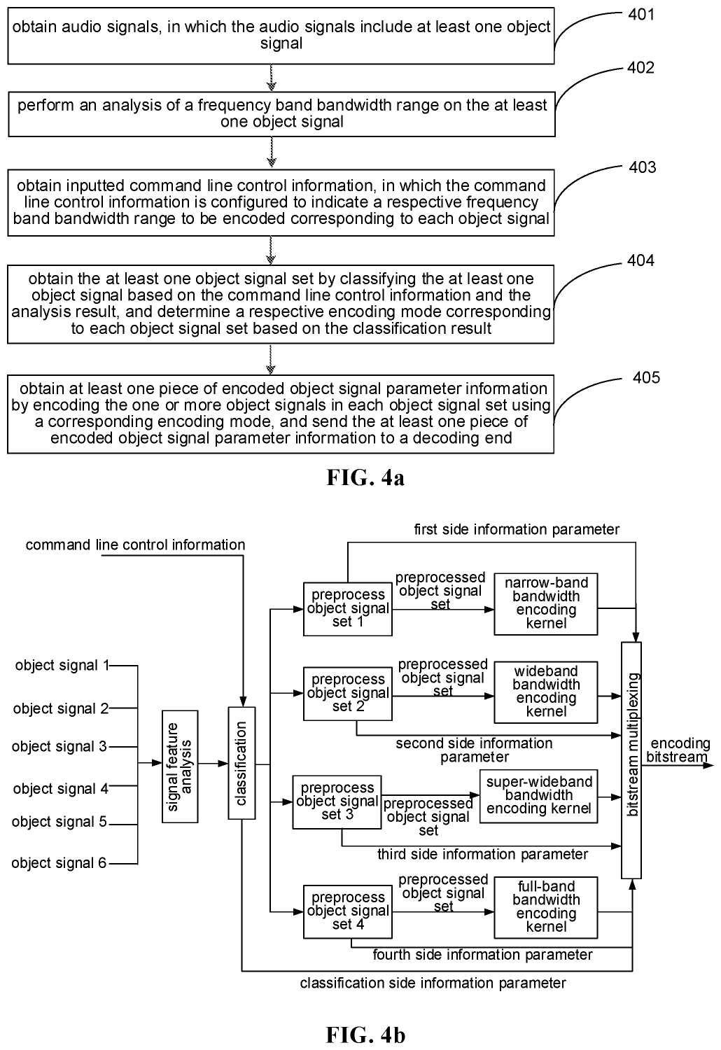

FIG. 4a is a flowchart illustrating a method for encoding or decoding a signal according to an embodiment of the disclosure. The method is performed by an encoding end. As illustrated in FIG. 4a, the method includes the following.

At block 401, audio signals are obtained, in which the audio signals include at least one object signal.

At block 402, the analysis of the frequency band bandwidth range is performed on the at least one object signal.

At block 403, inputted command line control information is obtained, in which the command line control information is configured to indicate a frequency band bandwidth range to be encoded corresponding to each object signal.

In embodiments of the disclosure, the command line control information may be manually input to the encoding end. The frequency band bandwidth range to be encoded corresponding to the object signal indicated by the command line control information is not an actual frequency band bandwidth range of the object signal, but is user-defined.

For example, in an embodiment of the disclosure, when the actual frequency band bandwidth range of a certain object signal is a narrow band, but the user wants the object signal to be processed with a high precision, the frequency band bandwidth range indicated by the command line control information corresponding to the object signal may be a wideband. When the actual frequency band bandwidth range of a certain object signal is a wide band, but the user wants the object signal to be processed with a low precision, the frequency band bandwidth range indicated by the command line control information corresponding to the object signal may be a narrow band.

At block 404, the at least one object signal set is obtained by classifying the at least one object signal based on both the command line control information and the analysis result, and the respective encoding mode corresponding to each object signal set is determined based on the classification result.

In embodiments of the disclosure, obtaining the at least one object signal set by classifying the at least one object signal based on both the command line control information and the analysis result and determining the respective encoding mode corresponding to each object signal set based on the classification result include:
when the frequency band bandwidth range indicated by the command line control information differs from the frequency band bandwidth range derived from the analysis result, classifying the at least one object signal preferentially based on the frequency band bandwidth range indicated by the command line control information, and determining the respective encoding mode corresponding to each object signal set based on the classification result; or
when the frequency band bandwidth range indicated by the command line control information is identical to the frequency band bandwidth range derived from the analysis result, classifying the at least one object signal based on the frequency band bandwidth range indicated by the command line control information or the analysis result, and determining the respective encoding mode corresponding to each object signal set based on the classification result.

For example, in embodiments of the disclosure, assuming that the analysis result of an object signal is a super-wideband signal, but the frequency band bandwidth range indicated by the command line control information of the object signal is a full-band signal. In this case, it is possible to classify this object signal into the object signal set 4 based on the command line control information and determine the encoding mode corresponding to the object signal set 4 as a full-band encoding mode.

At block 405, at least one piece of encoded object signal parameter information is obtained by encoding the one or more object signals in each object signal set using a corresponding encoding mode, and the encoded object signal parameter information is sent to a decoding end.

The relevant description of the block 405 may be referred to the above description of embodiments, which is not repeated in embodiments of the disclosure.

Finally, based on the above-described contents, FIG. 4b is a flowchart illustrating a method for encoding a signal according to embodiments of the disclosure.

In conclusion, in the method for encoding or decoding a signal according to embodiments of the disclosure, the signal feature analysis may be performed on at least one object signal in the collected audio signals to obtain the analysis result. The at least one object signal may be classified based on the analysis result to obtain at least one object signal set. Meanwhile, the respective encoding mode corresponding to each object signal set may be determined based on the classification result. The one or more object signals in each object signal set may be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

FIG. 5 is a flowchart illustrating a method for encoding or decoding a signal according to an embodiment of the disclosure. The method is performed by a decoding end. As illustrated in FIG. 5, the method includes the following.

At block 501, at least one piece of encoded object signal parameter information sent by an encoding end is received.

In embodiments of the disclosure, the decoding end may be a UE or a base station.

At block 502, at least one decoded object signal set is obtained by decoding the encoded object signal parameter information.

In conclusion, in the method for encoding or decoding a signal according to embodiments of the disclosure, during the encoding process, signal feature analysis may be performed on at least one object signal in the collected audio signals to obtain an analysis result. The at least one object signal may be classified based on the analysis result to obtain at least one object signal set. Meanwhile, a respective encoding mode corresponding to each object signal set may be determined based on the classification result. One or more object signals in each object signal set may be encoded using a corresponding encoding mode. The signal feature analysis in embodiments of the disclosure includes the analysis of a frequency band bandwidth range of the signal. As may be seen that in embodiments of the disclosure, the frequency band bandwidth range of the signal is taken into account when determining the encoding mode, thereby ensuring the signal compression rate and saving bandwidth.

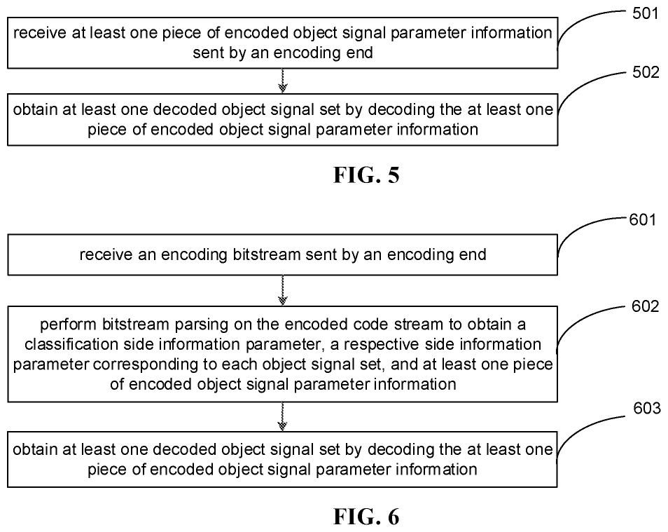

FIG. 6 is a flowchart illustrating a method for encoding or decoding a signal according to an embodiment of the disclosure. The method is performed by a decoding end. As illustrated in FIG. 6, the method includes the following.

At block 601, an encoding bitstream sent by an encoding end is received.

At block 602, bitstream parsing is performed on the encoding bitstream to obtain a classification side information parameter, a respective side information parameter corresponding to each object signal set, and at least one piece of encoded object signal parameter information.

The classification side information parameter is configured to indicate a classification manner for object signals, and the side information parameter is configured to indicate an encoding mode corresponding to the object signal set. The relevant introduction of the classification side information parameter and the side information parameter may be referred to the above description of embodiments, which is not repeated in embodiments of the disclosure.

At block 603, at least one decoded object signal set is obtained by decoding the at least one piece of encoded object signal parameter information.

In embodiments of the disclosure, the at least one piece of encoded object signal parameter is decoded based on the classification side information parameter and the side information parameter, to obtain at least one decoded object signal set. Details on specific decoding methods will be described in subsequent embodiments.

In conclusion, in the method for encoding or decoding a signal according to embodiments of the disclosure, during the encoding process, the signal feature analysis may be performed on at least one object signal in the collected audio signals to obtain an analysis result. The at least one object signal may be classified based on the analysis result to obtain at least one object signal set. Meanwhile, a respective encoding mode corresponding to each object signal set may be determined based on the classification result. The one or more object signals in each object signal set may be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

FIG. 7 is a flowchart illustrating a method for encoding or decoding a signal according to an embodiment of the disclosure. The method is performed by a decoding end. As illustrated in FIG. 7, the method includes the following.

At block 701, an encoding bitstream sent by an encoding end is received.

At block 702, bitstream parsing is performed on the encoding bitstream to obtain a classification side information parameter, a respective side information parameter corresponding to each object signal set, and at least one piece of encoded object signal parameter information.

The classification side information parameter is configured to indicate a classification manner for object signals, and the side information parameter is configured to indicate an encoding mode corresponding to the object signal set. The relevant introduction of the classification side information parameter and the side information parameter may be referred to the above description of embodiments, which is not repeated in embodiments of the disclosure.

At block 703, a classification manner for object signals is determined based on the classification side information parameter.

With reference to the above description of embodiments, it may be seen that when the classification manner for the object signals is different, the corresponding encoding condition is also different. In detail, in embodiments of the disclosure, when the classification manner for the object signals is a classification manner based on the cross-correlation parameter value between signal, the encoding condition corresponding to the encoding end is encoding each object signal set using a corresponding encoding mode with the same encoding kernel.

In other embodiments of the disclosure, when the classification manner for the object signals is a classification mode based on the frequency band bandwidth range, the encoding situation corresponding to the encoding end is encoding object signal sets using respective encoding mode with different encoding kernels.

Therefore, in this block, it needs to first determine the classification manner for the object signals used during the encoding process based on the classification side information parameter, to determine the encoding condition in the encoding process, based on which subsequent decoding process may be performed.

At block 704, a respective encoding mode corresponding to each encoded object signal parameter information is determined based on the side information parameter.

At block 705, the encoded object signal parameter information is decoded using a corresponding decoding mode that is based on the classification manner for the object signals and the encoding mode corresponding to the encoded object signal parameter information.

In embodiments of the disclosure, decoding the encoded object signal parameter information using the corresponding decoding mode that is based on the classification manner for the object signals and the encoding mode corresponding to the encoded object signal parameter information includes:
determining an encoding condition during an encoding process based on a classification manner, determining a corresponding decoding mode based on the encoding condition, and decoding the encoded object signal parameter information using a corresponding decoding mode that is based on the encoding mode corresponding to the encoded object signal parameter information in accordance with a corresponding encoding-decoding mode.

In detail, in embodiments of the disclosure, when the encoding condition in the encoding process determined based on the classification manner is encoding all the object signal sets using corresponding encoding modes with the same encoding kernel, it is determined that the decoding mode in the decoding process is adopting the same decoding kernel to decode all the encoded object signal parameter information. In the decoding process, the encoded object signal parameter information is decoded using a corresponding decoding mode that is based on the encoding mode corresponding to the encoded object signal parameter information, to obtain at least one decoded object signal set.

In other embodiments of the disclosure, when the encoding condition in the encoding process determined based on the classification manner is encoding the object signal sets using corresponding encoding modes with different encoding kernels, it is determined that the decoding mode in the decoding process is adopting different decoding kernels to decode all the encoded object signal parameter information. In the decoding process, the encoded object signal parameter information is decoded using a corresponding decoding mode that is based on the encoding mode corresponding to the encoded object signal parameter information, to obtain at least one decoded object signal set.

In conclusion, in the method for encoding or decoding a signal according to embodiments of the disclosure, during the encoding process, the signal feature analysis may be performed on at least one object signal in the collected audio signals to obtain an analysis result. The at least one object signal may be classified based on the analysis result to obtain at least one object signal set. Meanwhile, a respective encoding mode corresponding to each object signal set may be determined based on the classification result. The one or more object signals in each object signal set may be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

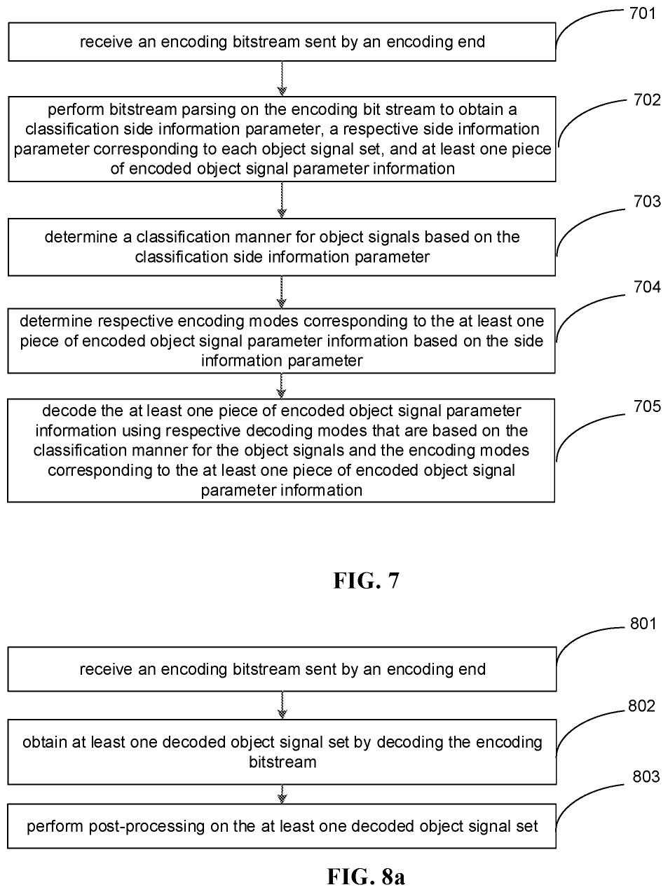

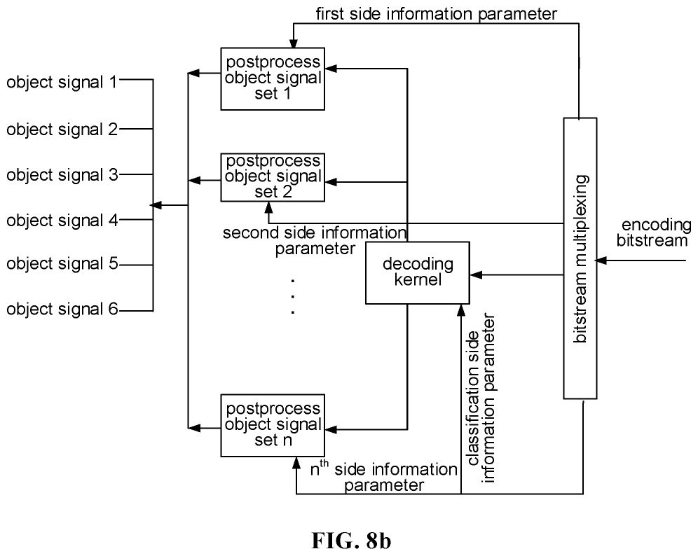

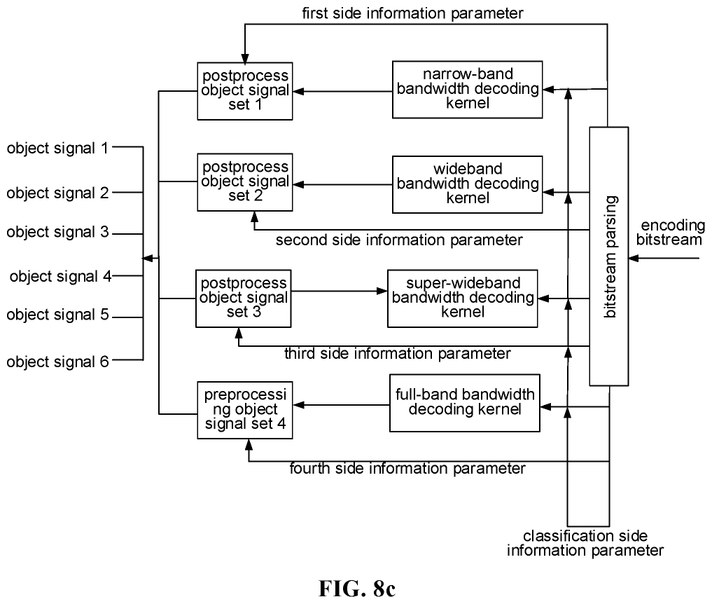

FIG. 8a is a flowchart illustrating a method for encoding or decoding a signal according to an embodiment of the disclosure. The method is performed by a decoding end. As illustrated in FIG. 8a, the method includes the following.

At block 801, an encoding bitstream sent by an encoding end is received.

At block 802, at least one decoded object signal set is obtained by decoding the encoding bitstream.

At block 803, post-processing is performed on the at least one decoded object signal set.

In embodiments of the disclosure, the post-processing may be a reverse process of the pre-processing process in preceding embodiments.

Specific details about blocks 801-803 may be described with reference to above described embodiments, which are not repeated in embodiments of the disclosure.

Finally, based on the above description, FIG. 8b is a flowchart illustrating a method for decoding a signal according to an embodiment of the disclosure. FIG. 8c is a flowchart illustrating a method for decoding a signal according to an embodiment of the disclosure.

In conclusion, in the method for encoding and decoding a signal according to embodiments of the disclosure, during the encoding process, the signal feature analysis may be performed on at least one object signal in the collected audio signals to obtain an analysis result. The at least one object signal may be classified based on the analysis result to obtain at least one object signal set. Meanwhile, the respective encoding mode corresponding to each object signal set may be determined based on the classification result. The one or more object signals in each object signal set may be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

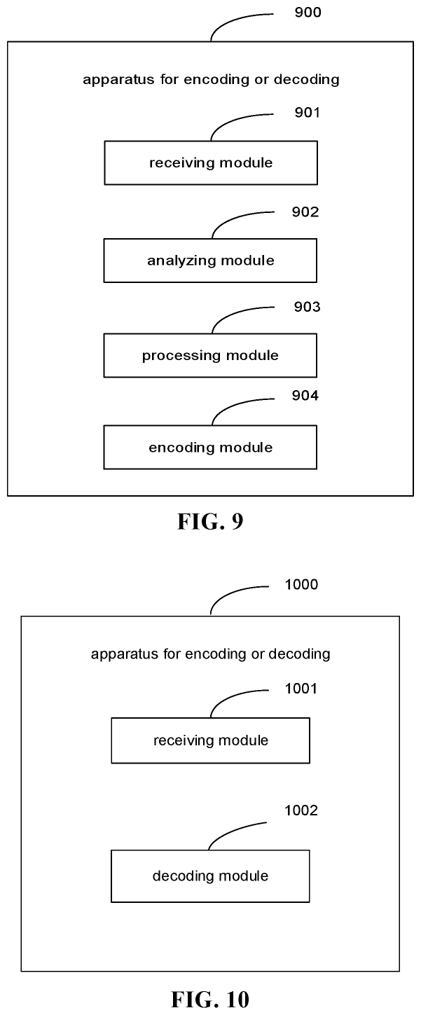

FIG. 9 is a schematic diagram of an apparatus for encoding or decoding a signal according to an embodiment of the disclosure. The apparatus is applied to an encoding end. As illustrated in FIG. 9, the apparatus 900 includes:
an obtaining module, configured to obtain audio signals, in which the audio signals include at least one object signal;
an analyzing module, configured to obtain an analysis result by performing signal feature analysis on the at least one object signal;
a processing module, configured to obtain at least one object signal set by classifying the at least one object signal based on the analysis result, and determine a respective encoding mode corresponding to each object signal set based on a classification result, in which the object signal set includes one or more object signals; and
an encoding module, configured to obtain at least one piece of encoded object signal parameter information by encoding the one or more object signals in each object signal set using a corresponding encoding mode, write the at least one pieces of encoded object signal parameter information to an encoding bitstream and send the encoding bitstream to a decoding end.

In conclusion, in the apparatus for encoding or decoding a signal according to embodiments of the disclosure, the signal feature analysis may be performed on the at least one object signal in the collected audio signals to obtain the analysis result. The at least one object signal may be classified based on the analysis result to obtain at least one object signal set. Meanwhile, the respective encoding mode corresponding to each object signal set may be determined based on the classification result. The one or more object signals in the object signal set may be encoded using a corresponding encoding mode. The signal feature analysis in embodiments of the disclosure includes the analysis of a frequency band bandwidth range of the signal. As may be seen that in embodiments of the disclosure, the frequency band bandwidth range of the signal is taken into account when determining the encoding mode, thereby ensuring the signal compression rate and saving bandwidth.

In embodiments of the disclosure, the apparatus is further configured to:
preprocess the at least one object signal set.

In embodiments of the disclosure, the encoding module is further configured to:
encode the one or more object signals in each object signal set after preprocessing using a corresponding encoding mode.

In embodiments of the disclosure, the encoding module is further configured to:
determine a classification side information parameter, in which the classification side information parameter is configured to indicate a classification manner for object signals;
determine a respective side information parameter corresponding to each object signal set, in which the side information parameter is configured to indicate a respective encoding mode corresponding to each object signal set; and
obtain the encoding bitstream by performing a bitstream multiplexing on the classification side information parameter, the respective side information parameter corresponding to each object signal set, and the encoded object signal parameter information, and send the encoding bitstream to the decoding end.

In embodiments of the disclosure, the analyzing module is further configured to:
perform a high-pass filtering process on the at least one object signal; and
perform a correlation analysis on the at least one object signal after the high-pass filtering process to determine cross-correlation parameter values between object signals.

In embodiments of the disclosure, the analyzing module is further configured to:
set normalized correlation degree intervals based on correlation degrees; and
obtain the at least one object signal set by classifying the at least one object signal based on the cross-correlation parameter values between the object signals and the normalized correlation degree intervals, and determine a corresponding encoding mode based on a respective correlation degree corresponding to each object signal set.

In embodiments of the disclosure, the encoding mode corresponding to the object signal set includes an independent encoding mode or a joint encoding mode.

In embodiments of the disclosure, the independent encoding mode corresponds to a time domain processing manner or a frequency domain processing manner;
in response to object signals in an object signal set being speech signals or speech-like signals, the independent encoding mode adopts the time domain processing manner; or
in response to object signals in an object signal set being audio signals other than the speech signals and the speech-like signals, the independent encoding mode adopts the frequency domain processing manner.

In embodiments of the disclosure, the encoding module is further configured to:
encode each object signal set using a corresponding encoding mode with the same encoding kernel.

In embodiments of the disclosure, the analyzing module is further configured to:
perform an analysis of a frequency band bandwidth range on the at least one object signal.

In embodiments of the disclosure, the processing module is further configured to:
determine bandwidth intervals corresponding to different frequency band bandwidths; and
obtain the at least one object signal set by classifying the at least one object signal based on a respective frequency band bandwidth range of each object signal and the bandwidth intervals corresponding to different frequency band bandwidths, and determine a corresponding encoding mode based on a respective frequency bandwidth corresponding to each object signal set.

In embodiments of the disclosure, the processing module is further configured to:
obtain inputted command line control information, in which the command line control information is configured to indicate a respective frequency band bandwidth range to be encoded corresponding to each object signal; and
obtain the at least one object signal set by classifying the at least one object signal based on the command line control information and the analysis result, and determine the respective encoding mode corresponding to each object signal set based on the classification result.

In embodiments of the disclosure, the encoding module is further configured to:
encode different object signal sets using corresponding encoding modes with different encoding kernels.

FIG. 10 is a block diagram illustrating an apparatus for encoding or decoding a signal according to an embodiment of the disclosure. The apparatus is applied to an encoding end. As illustrated in FIG. 10, the apparatus 1000 includes:
a receiving module, configured to receive at least one piece of encoded object signal parameter information sent by the encoding end; and
a decoding module, configured to obtain at least one decoded object signal set by decoding the at least one piece of encoded object signal parameter information.

In conclusion, in the apparatus for encoding or decoding a signal according to embodiments of the disclosure, the signal feature analysis may be performed on the at least one object signal in the collected audio signals to obtain the analysis result. The at least one object signal may be classified based on the analysis result to obtain at least one object signal set. Meanwhile, a respective encoding mode corresponding to each object signal set may be determined based on the classification result. The one or more object signals in each object signal set will be encoded using a corresponding encoding mode. The signal feature analysis in embodiments of the disclosure includes the analysis of the frequency band bandwidth range of the signal. As may be seen that in embodiments of the disclosure, the frequency band bandwidth range of the signal is taken into account when determining the encoding mode, thereby ensuring the signal compression rate and saving bandwidth.

In embodiments of the disclosure, the apparatus is further configured to:
perform bitstream parsing on the encoding bitstream to obtain a classification side information parameter, a respective side information parameter corresponding to each object signal set, and at least one piece of encoded object signal parameter information;
in which the classification side information parameter is configured to indicate a classification manner for object signals, and the side information parameter is configured to indicate a respective encoding mode corresponding to each object signal set.

In embodiments of the disclosure, the decoding module is further configured to:
determine a classification manner for object signals based on the classification side information parameter;
determine a respective encoding mode corresponding to each encoded object signal parameter information based on the side information parameter; and
decode each encoded object signal parameter information using a corresponding decoding mode that is based on the classification manner for the object signals and the respective encoding mode corresponding to each encoded object signal parameter information.

In embodiments of the disclosure, the classification side information parameter indicates that the classification manner for the object signals is classification based on an cross-correlation parameter value.

The decoding module is further configured to:
obtain at least one decoded object signal set by decoding the at least one pieces of encoded object signal parameter information using corresponding decoding modes with the same decoding kernel that are based on respective encoding modes of the encoded object signal parameter information.

In embodiments of the disclosure, the classification side information parameter indicates that the classification manner for the object signals is classification based on a frequency bandwidth range.

The decoding module is further configured to:
obtain at least one decoded object signal set by decoding the at least one pieces of encoded object signal parameter information using corresponding decoding modes with different decoding kernels that are based on the respective encoding mode corresponding to each encoded object signal parameter information.

In embodiments of the disclosure, the apparatus is further configured to:
perform post-processing on the at least one decoded object signal set.

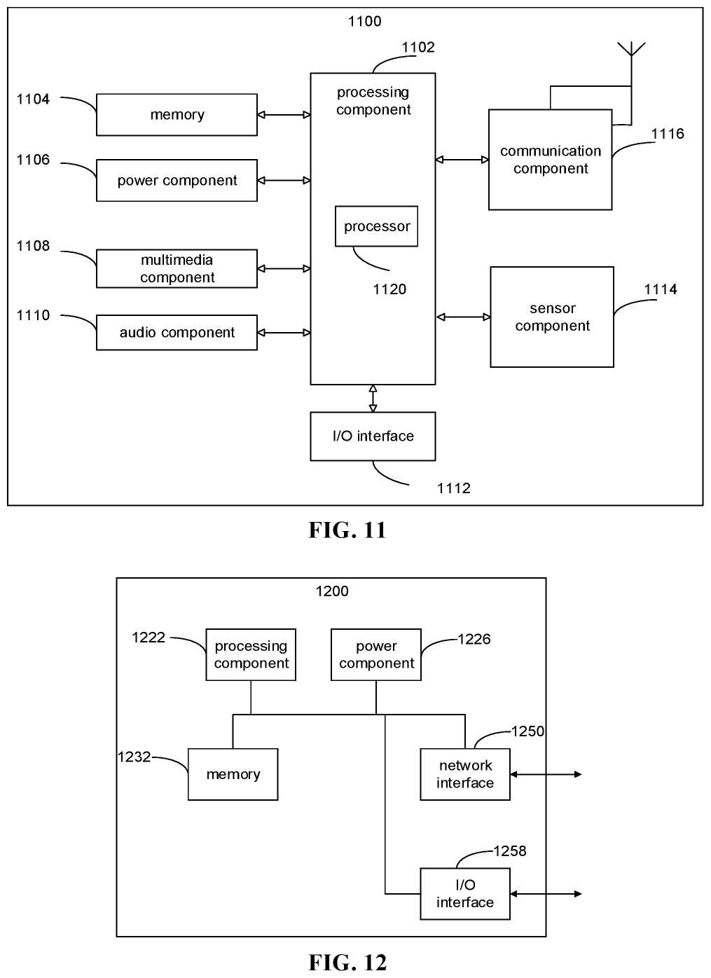

FIG. 11 is a block diagram illustrating a UE 1100 according to an embodiment of the disclosure. For example, the UE 1100 may be a mobile phone, a computer, a digital broadcasting terminal, a message transceiver device, a game console, a tablet device, a medical device, a fitness device and a personal digital assistant.

As illustrated in FIG. 11, the UE 1100 may include at least one of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the UE 1100, such as the operations associated with display, telephone calls, data communications, camera operations, and recording operations. The processing component 1102 may include at least one processor 1120 to execute instructions to perform all or part of the steps in the above described method. Moreover, the processing component 1102 may include at least one module which facilitates the interaction between the processing component 1102 and other components. For example, the processing component 1102 may include a multimedia module to facilitate the interaction between the multimedia component 1108 and the processing component 1102.

The memory 1104 is configured to store various types of data to support the operation of the UE 1100. Examples of such data include instructions for any applications or methods operated on the UE 1100, contact data, phonebook data, messages, pictures, videos, etc. The memory 1704 may be implemented using any type of volatile or non-volatile memory devices, or a combination thereof, such as a Static Random-Access Memory (SRAM), an Electrically-Erasable Programmable Read Only Memory (EEPROM), an Erasable Programmable Read Only Memory (EPROM), a Programmable Read Only Memory (PROM), a Read Only Memory (ROM), a magnetic memory, a flash memory, a magnetic or optical disk.

The power component 1106 provides power to various components of the UE 1100. The power component 1106 may include a power management system, at least one power source, and any other components associated with the generation, management, and distribution of power in the UE 1100.

The multimedia component 1108 includes a screen providing an output interface between the UE 1100 and the user. In some embodiments, the screen may include a Liquid Crystal Display (LCD) and a Touch Panel (TP). If the screen includes the touch panel, the screen may be implemented as a touch screen to receive input signals from the user. The touch panel includes at least one touch sensor to sense touches, swipes, and gestures on the touch panel. The touch sensor may not only sense a boundary of a touch or swipe action, but also sense a duration and a pressure associated with the touch or swipe action. In some embodiments, the multimedia component 1108 includes a front-facing camera and/or a rear-facing camera. When the UE 1100 is in an operating mode, such as a shooting mode or a video mode, the front-facing camera and/or the rear-facing camera may receive external multimedia data. Each front-facing camera and rear-facing camera may be a fixed optical lens system or has focal length and optical zoom capability.

The audio component 1110 is configured to output and/or input audio signals. For example, the audio component 1110 includes a microphone (MIC) configured to receive an external audio signal when the UE 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes at least one sensor to provide status assessments of various aspects of the UE 1100. For instance, the sensor component 1114 may detect an open/closed status of the UE 1100, relative positioning of components, e.g., the display and the keypad, of the UE 1100, a change in position of the UE 1100 or a component of the UE 1100, a presence or absence of user contact with the UE 1100, an orientation or an acceleration/deceleration of the UE 1100, and a change in temperature of the UE 1100. The sensor component 1114 may include a proximity sensor configured to detect the presence of nearby objects without any physical contact. The sensor component 1114 may also include a light sensor, such as a Complementary Metal Oxide Semiconductor (CMOS) or a Charge-Coupled Device (CCD) image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the UE 1100 and other devices. The UE 1100 may access a wireless network based on a communication standard, such as Wi-Fi, 2G or 3G, or a combination thereof. In an embodiment, the communication component 1116 receives a broadcast signal from an external broadcast management system or broadcast associated information via a broadcast channel. In an embodiment, the communication component 1116 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Blue Tooth (BT) technology, and other technologies.

In an embodiment, the UE 1100 may be implemented with at least one Application Specific Integrated Circuit (ASIC), Digital Signal Processor (DSP), Digital Signal Processing Device (DSPD), Programmable Logic Device (PLD), Field Programmable Gate Array (FPGA), controller, micro-controller, microprocessor or other electronic components, for performing the above described method.

FIG. 12 is a block diagram illustrating a network side device 1200 according to an embodiment of the disclosure. For example, the network side device 1200 may be provided as a network side device. As illustrated in FIG. 12, the network side device 1200 includes a processing component 1222, which further includes at least one processor, and memory resources represented by a memory 1232 for storing instructions that may be executed by the processing component 1222, such as an application program. The application programs stored in the memory 1232 may include one or more modules each corresponding to a set of instructions. In addition, the processing component 1222 is configured to execute instructions to perform any methods applied to the network side device as described in the foregoing method, e.g., the method shown in FIG. 1.

The network side device 1200 may also include a power component 1226 configured to perform power management of the network side device 1200, a wired or wireless network interface 1250 configured to connect the network side device 1200 to a network, and an input/output (I/O) interface 1258. The network side device 1200 may operate based on an operating system stored in the memory 1232, such as Windows Server™, Mac OS X™, Unix™, Linux™, Free BSD™ or the like.

In above embodiments of the disclosure, the methods according to embodiments of the disclosure are described from the perspectives of the network side device and the UE, respectively. In order to realize each of the functions in the methods provided by the above embodiments of the disclosure, the network side device and the UE may include a hardware structure, a software module, and realize each of the above functions in the form of the hardware structure, the software module, or a combination of the hardware structure and the software module. A certain function of the above functions may be performed in the form of a hardware structure, a software module, or a combination of the hardware structure and the software module.

In above embodiments of the disclosure, the methods according to embodiments of the disclosure are described from the perspectives of the network side device and the UE, respectively. In order to realize each of the functions in the methods provided by the above embodiments of the disclosure, the network side device and the UE may include a hardware structure, a software module, and realize each of the above functions in the form of the hardware structure, the software module, or a combination of the hardware structure and the software module. A certain function of the above functions may be performed in the form of a hardware structure, a software module, or a combination of the hardware structure and the software module.

Embodiments of the disclosure provide a communication device. The communication device may include a transceiver module and a processing module. The transceiver module may include a sending module and/or a receiving module. The sending module is used for realizing a sending function, and the receiving module is used for realizing a receiving function. The transceiver module may realize the sending function and/or the receiving function.

The communication device may be a terminal device (e.g., the terminal device in the foregoing method embodiments), a device in the terminal device, or a device that may be used in combination with the terminal device. Or, the communication device may be a network device, a device in the network device, or a device that may be used in combination with the network device.

Embodiments of the disclosure provides another communication device. The communication device may be a network device or a terminal device (e.g., the terminal device in the above method embodiments), or may be a chip, a chip system or a processor that supports the network device to realize the above-described methods, or may be a chip, a chip system or a processor that supports the terminal device to realize the above-described methods. The device may be used to realize the methods described in the above method embodiments with reference to the description of the above-described method embodiments.

The communication device may include one or more processors. The processor may be a general purpose processor or a dedicated processor, such as, a baseband processor and a central processor. The baseband processor is used for processing communication protocols and communication data. The central processor is used for controlling the communication device (e.g., a network side device, a baseband chip, a terminal device, a terminal device chip, a central unit (CU), or a distributed unit (DU)), executing computer programs, and processing data of the computer programs.

In some embodiments, the communication device may include one or more memories on which computer programs may be stored. The processor executes the computer programs to cause the communication device to perform the methods described in the above method embodiments. In some examples, the memory may also store data. The communication device and the memory may be provided separately or may be integrated together.

In some examples the communication device may also include a transceiver and an antenna. The transceiver may be referred to as a transceiver unit, a transceiver machine, or a transceiver circuit, for realizing a transceiver function. The transceiver may include a receiver and a transmitter. The receiver may be referred to as a receiving machine or a receiving circuit, for realizing a receiving function. The transmitter may be referred to as a transmitter machine or a transmitting circuit, for realizing a transmitting function.

In some examples the communication device may also include one or more interface circuits. The interface circuits are used to receive code instructions and transmit the code instructions to the processor. The processor runs the code instructions to cause the communication device to perform the method described in the method embodiments.

The communication device is a terminal device (such as the terminal device in the preceding method embodiments). The processor is used to perform the method shown in any of FIGS. 1 to 4a.

The communication device is a network device. The transceiver is used to perform the method shown in any of FIGS. 5 to 7.

In an implementation, the processor may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor may store a computer program. When the computer program runs on the processor, the communication device is caused to perform the methods described in the method embodiments above. The computer program may be solidified in the processor, and in such case, the processor may be implemented by hardware.

In an implementation, the communication device may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a network device or a terminal device (e.g., the terminal device in the preceding method embodiments), but the scope of the communication device described in the disclosure is not limited thereto, and the structure of the communication device may not be limited by FIG. 12. The communication device may be a stand-alone device or may be part of a larger device. For example, the described communication device may be:
(1) a stand-alone IC, a chip, a chip system or a subsystem;
(2) a collection of ICs including one or more ICs, as an example the collection of ICs may also include storage components for storing data and computer programs;
(3) an ASIC, such as a modem;
(4) a module that may be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

The communication device may be a chip or a chip system. The chip includes a processor and an interface. There may be one or more processors, and there may be multiple interfaces.

In some examples the chip further includes a memory used to store necessary computer programs and data.

It is understandable by those skilled in the art that various illustrative logical blocks and steps listed in embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of embodiments of the disclosure.

Embodiments of the disclosure also provide a system. The system includes a communication device as a terminal device in the foregoing embodiment (such as the first terminal device in the foregoing method embodiment) and a communication device as a network device. Or, the system includes a communication device as a terminal device in foregoing embodiments (such as the first terminal device in foregoing method embodiments) and a communication device as a network device.

The disclosure also provides a readable storage medium having instructions stored thereon. When the instructions are executed by a computer, the functions of any of the above method embodiments are implemented.

The disclosure also provides a computer program product. When the computer program product is executed by a computer, the functions of any of the above method embodiments are implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

In conclusion, with the signal encoding and decoding methods, the related apparatuses, the encoding device, the decoding device and the storage medium according to embodiments of the disclosure, signal feature analysis may be performed on the at least one object signal in the collected audio signals to obtain the analysis result. The at least one object signal may be classified based on the analysis result to obtain at least one object signal set. Meanwhile, the encoding mode corresponding to each object signal set may be determined based on the classification result. Each object signal in the object signal set may be encoded using the corresponding encoding mode. The signal feature analysis in embodiments of the disclosure includes the analysis of a cross-correlation parameter value between signals or the analysis of a frequency band bandwidth range of the signal. As may be seen that in embodiments of the disclosure, the cross-correlation parameter value between signals or the frequency band bandwidth range of the signal is taken into account when determining the encoding mode, thereby ensuring the signal compression rate and saving bandwidth.

Those skilled in the art may understand that the first, second, and other various numerical numbers involved in the disclosure are only described for the convenience of differentiation, and are not used to limit the scope of embodiments of the disclosure, or used to indicate the order of precedence.

The term “at least one” in the disclosure may also be described as one or more, and the term “multiple” may be two, three, four, or more, which is not limited in the disclosure. In embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

Other embodiments of the disclosure will be apparent to those skilled in the art from consideration of the specification and practice of the disclosure disclosed here. The disclosure is intended to cover any variations, uses, or adaptations of the disclosure following the general principles thereof and including such departures from the disclosure as come within known or customary practice in the art. It is intended that the specification and examples be considered as illustrative only, with a true scope of the disclosure being indicated by the following claims.

It will be appreciated that the disclosure is not limited to the exact construction that has been described above and illustrated in the accompanying drawings, and that various modifications and changes may be made without departing from the scope thereof. It is intended that the scope of the disclosure only be limited by the appended claims.

1. A method for encoding a signal, performed by an encoding end, comprising:
obtaining audio signals, wherein the audio signals comprise at least one object signal;
obtaining an analysis result by performing signal feature analysis on the at least one object signal;
obtaining at least one object signal set by classifying, based on the analysis result, the at least one object signal, and determining a respective encoding mode corresponding to each object signal set based on a classification result, wherein the object signal set comprises one or more of the at least one object signal; and
obtaining at least one piece of encoded object signal parameter information by encoding the one or more of the at least one object signal in each object signal set using the respective encoding mode, writing the at least one piece of encoded object signal parameter information to an encoding bitstream and sending the encoding bitstream to a decoding end.

2. The method of claim 1, further comprising:
preprocessing the at least one object signal set;
wherein encoding the one or more of the at least one object signal in each object signal set using the respective encoding mode comprises:
encoding the one or more of at least one object signal in each object signal set after preprocessing using the respective encoding mode.

3. (canceled)

4. The method of claim 2, wherein writing the at least one piece of encoded object signal parameter information to the encoding bitstream and sending the encoding bitstream to the decoding end comprises:
determining a classification side information parameter, wherein the classification side information parameter is configured to indicate a classification manner for object signals;
determining a respective side information parameter corresponding to each object signal set, wherein the side information parameter is configured to indicate an encoding mode corresponding to the object signal set; and
obtaining the encoding bitstream by perform a bitstream multiplexing on the classification side information parameter, the respective side information parameter corresponding to each object signal set, and the at least one piece of encoded object signal parameter information, and sending the encoding bitstream to the decoding end.

5. The method of claim 1, wherein obtaining the analysis result by performing the signal feature analysis on the at least one object signal comprises:
performing a high-pass filtering process on the at least one object signal; and
performing a correlation analysis on the at least one object signal after the high-pass filtering process to determine cross-correlation parameter values between object signals;
wherein the at least one object signal comprises two or more object signals.

6. The method of claim 5, wherein obtaining the at least one object signal set by classifying the at least one object signal based on the analysis result, and determining the respective encoding mode corresponding to each object signal set based on the classification result comprises:
setting normalized correlation degree intervals based on correlation degrees; and
obtaining the at least one object signal set by classifying the at least one object signal based on the cross-correlation parameter values between the object signals and the normalized correlation degree intervals, and determining the respective encoding mode based on a respective correlation degree corresponding to each of the at least one object signal set.

7. The method of claim 5, wherein the encoding mode corresponding to an object signal set comprises an independent encoding mode or a joint encoding mode;
wherein the independent encoding mode corresponds to a time domain processing manner or a frequency domain processing manner;
in response to each object signal in an object signal set being a speech signal or a speech-like signal, the independent encoding mode adopts the time domain processing manner; or
in response to each object signal in an object signal set being an audio signal other than the speech signal and the speech-like signal, the independent encoding mode adopts the frequency domain processing manner.

8. (canceled)

9. The method of claim 5, wherein encoding the one or more of the at least one object signal in each object signal set using the respective encoding mode comprises:
encoding all of the at least one object signal set using respective encoding modes with a same encoding kernel.

10. The method of claim 1, wherein obtaining the analysis result by performing the signal feature analysis on the at least one object signal comprises:
perform an analysis of a frequency band bandwidth range on the at least one object signal.

11. The method of claim 10, wherein obtaining the at least one object signal set by classifying the at least one object signal based on the analysis result, and determining the respective encoding mode corresponding to each object signal set based on the classification result comprise:
determining bandwidth intervals corresponding to different frequency bandwidths; and
obtaining the at least one object signal set by classifying the at least one object signal based on the frequency band bandwidth ranges of the at least one object signal and the bandwidth intervals corresponding to different frequency bandwidths, and determining the respective encoding mode based on the frequency bandwidths corresponding to the at least one object signal set.

12. The method of claim 10, wherein obtaining the at least one object signal set by classifying the at least one object signal based on the analysis result, and determining the respective encoding mode corresponding to each object signal set based on the classification result comprise:
obtaining inputted command line control information, wherein the command line control information is configured to indicate a respective frequency band bandwidth range to be encoded corresponding to each object signal; and
obtaining the at least one object signal set by classifying the at least one object signal based on the command line control information and the analysis result, and determining the respective encoding mode corresponding to each object signal set based on the classification result.

13. The method of claim 7, wherein encoding the one or more object signals in each object signal set using the respective encoding mode comprises:
encoding different object signal sets using respective encoding modes with different encoding kernels.

14. A method for decoding a signal, performed by a decoding end, comprising:
receiving an encoding bitstream sent by an encoding end; and
obtaining at least one decoded object signal set by decoding the encoding bitstream.

15. The method of claim 14, further comprising:
performing bitstream parsing on the encoding bitstream to obtain a classification side information parameter, a respective side information parameter corresponding to each object signal set, and at least one piece of encoded object signal parameter information;
wherein the classification side information parameter is configured to indicate a classification manner for object signals, and the side information parameter is configured to indicate an encoding mode corresponding to the object signal set.

16. The method of claim 15, wherein obtaining the at least one object signal set by decoding the encoding bitstream comprises:
determining a classification manner for the object signals based on the classification side information parameter;
determining a respective encoding mode corresponding to each encoded object signal parameter information based on the side information parameter; and
decoding the at least one piece of encoded object signal parameter information using respective decoding modes that are based on the classification manner for the object signals and the respective encoding modes corresponding to the at least one piece of encoded object signal parameter information.

17. The method of claim 16, wherein the classification side information parameter indicates that the classification manner for the object signals is classification based on an cross-correlation parameter value; and
decoding the at least one piece of encoded object signal parameter information using the respective decoding modes that are based on the classification manner for the object signals and the respective encoding modes corresponding to the at least one piece of encoded object signal parameter information comprises:
obtaining at least one decoded object signal set by decoding the at least one piece of encoded object signal parameter information using respective decoding modes with a same decoding kernel that are based on the encoding modes of the at least one piece of encoded object signal parameter information;
wherein the method further comprises: performing post-processing on the at least one decoded object signal set.

18. The method of claim 16, wherein the classification side information parameter indicates that the classification manner for the object signals is classification based on a frequency bandwidth range; and
decoding the at least one piece of encoded object signal parameter information using the respective decoding modes that are based on the classification manner for the object signals and the respective encoding modes corresponding to the at least one piece of encoded object signal parameter information comprises:
obtaining at least one decoded object signal set by decoding the at least one piece of encoded object signal parameter information using respective decoding modes with different decoding kernels that are based on the encoding modes of the at least one piece of encoded object signal parameter information;
wherein the method further comprises: performing post-processing on the at least one decoded object signal set.

19-21. (canceled)

22. A communication device, comprising a processor and a memory a having computer program stored thereon, wherein when the processor executes the computer program, the device is configured to:
obtain audio signals, wherein the audio signals comprise at least one object signal;
obtain an analysis result by performing signal feature analysis on the at least one object signal;
obtain at least one object signal set by classifying, based on the analysis result, the at least one object signal, and determine a respective encoding mode corresponding to each object signal set based on a classification result, wherein each object signal set comprises one or more object signals; and
obtain at least one piece of encoded object signal parameter information by encoding the one or more object signals in each object signal set using a respective encoding mode, write the at least one piece of encoded object signal parameter information to an encoding bitstream and send the encoding bitstream to a decoding end.

23. A communication device, comprising a processor and a memory having a computer program stored thereon, wherein when the processor executes the computer program, the device is caused to perform the method of claim 14.

24-25. (canceled)

26. A non-transitory computer readable storage medium, for storing instructions, wherein when the instructions are executed, the method of claim 1 is performed.

27. A non-transitory computer readable storage medium, for storing instructions, wherein when the instructions are executed, the method of claim 14 is performed.
